(19) United States
(12) Patent Application Publication
(10) Pub. No.: US 2010/0095067 A1
(43) Pub. Date: Apr. 15, 2010

(54) Caching Web Page Elements In Accordance With Display Locations Of The Elements

(75) Inventors: Ravi K. Kosaraju, Middle Island, NY (US); William G. Pagan, Durham, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 12/250,964

(22) Filed: Oct. 14, 2008

(51) Int. Cl. G06F 12/08

(52) U.S. Cl. 711/126; 711/E12.041

(57) ABSTRACT

Methods, apparatus, and products for caching web page elements in accordance with display locations of the elements, including maintaining, by a web browser in accordance with a cache retention policy, a local cache of previously displayed web page elements in dependence upon previous display locations of the elements including maintaining a cache retention score for each locally cached element; and displaying, by the web browser, a previously displayed web page including displaying one or more of the locally cached elements.

### BACKGROUND OF THE INVENTION

1. Field of the Invention

The field of the invention is data processing, or, more specifically, methods, apparatus, and products for caching web page elements in accordance with display locations of the elements.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Computers today are increasingly used in mobile applications, personal digital assistants (PDA), mobile phones, notebook computers, and so on. Accessing the Internet with such devices typically requires a mobile data communications service plan provided by an Internet Service Provider (‘ISP’). Such data communications service plans may have data communications ‘caps,’ a limit on a customer usage data communications usage, or costs that vary with data communications usage, such as per kilobyte charges for example. Web pages accessed by use of such data communications service plans may include many elements which a user never actually views through a Graphical User Interface (‘GUI’) web browser window because the user never scrolls the window down to view such elements. These elements, however, are typically still downloaded to the mobile device, costing the customer usage charges or increasing the customer's usage closer to the service plan limit. As such, there is a need for improvement in downloading and caching such web page elements, especially in devices operating within a usage cap service plan or a service plan with costs that vary according to data communications usage.

### SUMMARY OF THE INVENTION

Methods, apparatus, and products for caching web page elements in accordance with display locations of the elements, including maintaining, by a web browser in accordance with a cache retention policy, a local cache of previously displayed web page elements in dependence upon previous display locations of the elements including maintaining a cache retention score for each locally cached element; and displaying, by the web browser, a previously displayed web page including displaying one or more of the locally cached elements.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of an exemplary system for caching web page elements in accordance with display locations of the elements according to embodiments of the present invention.

FIG. 2 sets forth a flow chart illustrating an exemplary method for caching web page elements in accordance with display locations of the elements according to embodiments of the present invention.

FIG. 3 sets forth a flow chart illustrating a further exemplary method for caching web page elements in accordance with display locations of the elements according to embodiments of the present invention.

FIG. 4 sets forth a flow chart illustrating a further exemplary method for caching web page elements in accordance with display locations of the elements according to embodiments of the present invention.

FIG. 5 sets forth a flow chart illustrating a further exemplary method for caching web page elements in accordance with display locations of the elements according to embodiments of the present invention.

### DETAILED DESCRIPTION OF EXEMPLARY EMBODIMENTS

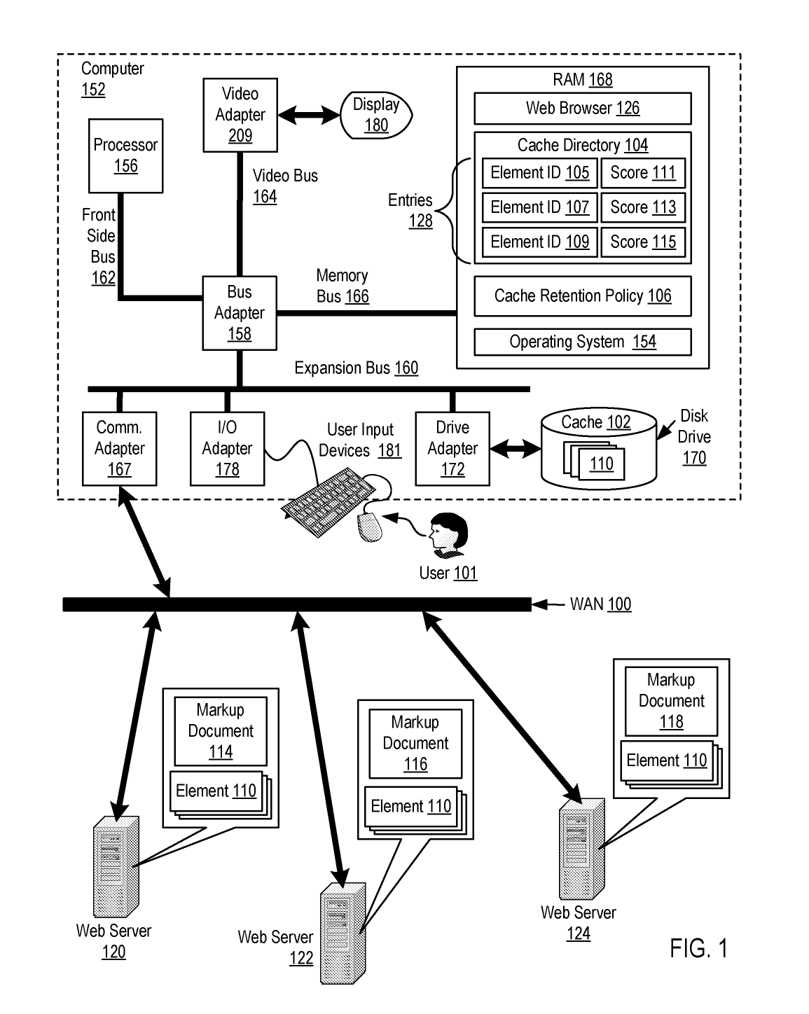

Exemplary methods, apparatus, and products for caching web page elements in accordance with display locations of the elements in accordance with the present invention are described with reference to the accompanying drawings, beginning with FIG. 1. FIG. 1 sets forth a network diagram of an exemplary system for caching web page elements in accordance with display locations of the elements according to embodiments of the present invention. The system of FIG. 1 includes a computer (152) which in turn includes at least one computer processor (156) or ‘CPU’ as well as random access memory (168) (‘RAM’) which is connected through a high speed memory bus (166) and bus adapter (158) to processor (156) and to other components of the computer (152). The example computer (152) of FIG. 1 is connected for data communications through a Wide Area Network (‘WAN’) (100) to a number of web servers (120, 122, 124), each server hosting a different web page, described by a markup document (114, 116, 118), such as a HyperText Markup Language (‘HTML’) document and including web page elements (110). A web server (120, 122, 124) as the term is used here refers to the computer hardware and computer software configured to host web pages and accept HyperText Transfer Protocol (‘HTTP’) requests from web clients, known as web browsers, and serving the browsers HTTP responses along with optional data content, which may include HTML documents and web page elements.

Stored in RAM (168) is a web browser (126), a module of computer program instructions that enables a user (101), through a graphical user interface (‘GUI’), to display and interact with text, images, videos, music, games, and other information located on a web page at a website. The example web browser (126) in the system of FIG. 1 operates generally for caching web page elements in accordance with display locations of the elements according to embodiments of the present invention. A web page element as the term is used in this specification is information stored on a web server, identified in a markup language document describing a particular web page, for display in a GUI browser window of a web browser when a user (101) instructs the web browser to access or display the particular web page. Examples of web page elements include frames, contents of frames, images, title bars, tables, search boxes, drop-down lists, and so on as will occur to readers of skill in the art. A display location is a location of a web page when displayed in GUI browser window in relation to a specified display region of the GUI browser window. A display region of the GUI browser window is an area, specified by dimensions and an origin, where the origin corresponds to a location within the GUI browser window. A display region of the GUI browser window is a region of a user's (101) computer display (180), specified by dimensions and an origin that corresponds to a location within the GUI browser window, which is used in administering caching of web page elements displayed inside and outside the region. The display region and GUI window overlap. In many embodiments, the display region is equivalent in size and shape to GUI display window itself, where the origin of the display region is in the upper-left hand corner region and aligns the region with the GUI display window. That is, for this example, any elements having display locations within the GUI display window also have display locations within the display region as the two are identical in size, shape, and alignment. Readers of skill in the art will recognize that such a display region may dynamically change in size during operation of the web browser and in accordance with changes of size in the GUI browser window. Consider, for example, that a user (101) reduces the size of the GUI window horizontally by a particular amount and the display region is also reduced in size horizontally by the same particular amount, insuring that the display region and GUI browser window keep the same size, shape, and alignment dynamically, through operation of the web browser. In other embodiments the display region may have a fixed size, such as the size of a user's computer display, 1280×720 for example. In other embodiments, the display region may be smaller or larger than the GUI browser window. Consider as an example a browser window of 800×600 and a display region of 1024×768, where the origin of the display region corresponds to the upper-left corner of the browser window. In such an embodiment, the display region is larger than the browser window.

The example web browser (126) in the system of FIG. 1 operates generally for caching web page elements in accordance with display locations of the elements according to embodiments of the present invention by maintaining, by the web browser (126) in accordance with a cache retention policy (106), a local cache (102) of previously displayed web page elements (110) in dependence upon previous display locations of the elements (110) and displaying, by the web browser (126), a previously displayed web page including displaying one or more of the locally cached elements (110).

A cache retention policy (106) is a set of rules applied by the web browser (126) in administering the caching of web page elements (110). Such rules may specify, for example, when to cache a web page element, when to retrieve non-cached web page elements for display, when to increase or decrease cache retention scores for cached web page elements, when to evict cached web page elements from the cache, and so on as will occur to readers of skill in the art.

Maintaining, by the web browser (126) in accordance with a cache retention policy (106), a local cache (102) of previously displayed web page elements (110) in dependence upon previous display locations of the elements (110) includes maintaining a cache retention score (111, 113, 115) for each locally cached element (110). A cache retention score (111, 113, 115) as the term is used in this specification is a value associated with a particular cached web page element that is used to determine when that element is to be evicted from the cache. The web browser (126) maintain a cache retention score for each element in a cache directory (104), a data structure including a number of entries (128) with each entry associating an element identifier (105, 107, 109) with a cache retention score (111, 113, 115). An element identifier (105, 107, 109) may be any value that uniquely identifies the cached element (110), such as for example, a concatenation of the Uniform Resource Locator (‘URL’) specifying the remote location from which the element was retrieved, the URL of the website hosting the web page that includes the element, and the current local file system storage location in the cache. The element identifier may also be implemented as a web browser defined identification, a unique ID, assigned to the element by storing the unique ID in metadata of the file representing the element stored in the cache. Readers of skill in the art will immediately recognize that maintaining a cache retention score (111, 113, 115) in a cache directory (104) is but one way among many to maintain a cache retention score (111, 113, 115) for a cached web page element (110). As an alternative to a cache directory (104), for example, the web browser (126) may also maintain cache retention scores for elements directly in metadata of the files representing the elements stored in cache.

The web browser may maintain a cache retention score for each locally cached element by some combination of increasing the cache retention score of the previously cached element for subsequent displays of the element, decreasing the cache retention score when the cached element has not been displayed for a predefined period of time, and so on as will occur to readers of skill in the art. The web browser (126) may evict, from the local cache (102), one or more elements (110) in the cache (102) in dependence upon the cache retention score (111, 113, 115) of the elements (110). The web browser (126) may, for example, be configured to evict ten elements having the lowest cache retention score once a day. As another example, consider that the cache (102) is of a limited size. In such an embodiment, the web browser may be configured to evict a particular number of elements having the lowest cache retention score only when the cache is full and another, presently non-cached element is to be stored in the cache. Such cache eviction policies are described here for clarity of explanation only, not limitation. Readers of skill in the art will recognize that many other cache eviction policies may modified for web browsers cache web page elements in accordance with display locations of the elements according to embodiments of the present invention, and each such policy is well within the scope of the present invention.

The example web browser (126) in the system of FIG. 1 may maintain a local cache (102) of previously displayed web page elements (110) in dependence upon previous display locations of the elements (110) by: retrieving, upon a first display of the web page from a server, a markup document describing the web page; retrieving, in dependence upon the markup document, only elements of the web page to be displayed within a display region of a web browser window defined by an origin location; and storing the retrieved elements in the cache. A first display of a web page as used here is an access of a web page with no elements of the web page stored in cache. That is, a first display of a web page need not be the only display of the web page by the web browser, but may also be a display of the web page after all previously cached elements of the web page have been evicted. A markup document is a document written in markup language that annotates information and represents instructions regarding the structure of the information or display of the information. Examples of markup documents include HTML documents, extensible markup language (AMU) documents, extensible HTML (‘HTML’) documents, and so on as will occur to readers of skill in the art. The web browser may retrieve the markup language document through a HyperText Transfer Protocol (HTTP) GET request. The web browser (126) may then retrieve only elements of the web page to be displayed within the display region by retrieving and displaying elements in a GUI browser window and consequently the overlapping display region, one by one, beginning at the upper left corner of the display region and continuing left-to-right and top-to-bottom, until the display region is filled with elements. The web browser (126) may retrieve such elements through HTTP GET, using URLs identifying storage locations of the elements. Consider as an example that a web page includes sixteen images of equal size, and the first eight images fill the GUI browser window, which has the same size and alignment as the display region. In such an example embodiment, the web browser retrieves and displays the first eight images, one by one, until the display region is filled.

From time to time, however, a user (101) may change the display region with respect to the web page, by vertically, diagonally, or horizontally scrolling in the GUI window—translating the display of the web page with respect to the origin location of the display region. Such a change in the display region with respect to the web page may be carried out as an example by a user (101) scrolling down the display of the web page in the GUI browser window. In such an embodiment some of the previously retrieved and displayed elements may no longer remain in the display region and other elements of the web page may not yet be retrieved for display. Responsive to such a change in the display region, therefore, the web browser (126) may retrieve, from the server (120, 122, 124), elements (110) of the web page to be displayed within the changed display region of the web browser window and store the retrieved elements of the changed display region in the cache (102). The web browser (126) may retrieve the elements (110) of the changed display region in a similar manner as that described above with respect to the previously retrieved elements of the same web page—retrieving and displaying elements in a GUI browser window, one by one, until the display region is filled with elements.

By only retrieving elements of a web page to be displayed in a particular display region, a user may reduce data communications necessary in accessing web pages and the Internet. Many data communications service plans provided by Internet Service Providers (‘ISPs’) to customers are designed to charge customers, or computer users, in dependence upon the amount of the customer's data communications in accessing the Internet or limit the user to a maximum amount of data communications over a period of time. Reducing data communications necessary to access web pages, therefore, may reduce user's costs, and increase efficiency in a user's Internet access.

The web browser (126) in the example system of FIG. 1 may display one or more of the locally cached elements (110) in dependence upon the display locations of the elements by retrieving, by the web browser (126) from a server (120, 122, 124), a markup document (114, 116, 118) describing the web page; retrieving, in dependence upon the markup document (114, 116, 118), only elements (110) of the web page not stored in the cache (102) to be displayed within a display region of a GUI browser window defined by an origin location; and displaying only elements of the web page, retrieved or previously cached, having a display location within the display region of the web browser window. The web browser (126) may retrieve only elements (110) of the web page not stored in the cache (102) to be displayed within a display region of a GUI browser window by displaying elements, in the GUI browser window and consequently the overlapping display region, one by one, beginning at the upper left corner of the display region and continuing left-to-right and top-to-bottom, until the display region is filled with elements, where previously cached elements are displayed from the cache and non-cached elements are retrieved from the server. Consider for example, that the web browser (126) in displaying a web page displays in the display region of the GUI browser window, a first, previously cached element, determines that the second element to display is not in the cache, retrieves the element from the server, displays the second element, determines that the third element to display is not in the cache, retrieves the third element from the server, displays the third element, displays a fourth, previously cached element, and so on until the display region of the GUI browser window is filled. As mentioned above, the web browser may store all previously non-cached, now retrieved elements in the cache any increase the cache retention score of any previously cached elements displayed in the display region of the GUI browser window displaying the web page.

Attributes in the HTML document describing a web page may also indicate a display size or a display location of a web page element. Attributes in an HTML document may indicate, for example, that a particular image is 200 pixels in width and 300 pixels in height. Instead of retrieving and displaying elements one by one until the display region is filled, the web browser (126) may retrieve elements to fill the region prior to display in dependence upon the attributes in the HTML documents.

Also stored in RAM (168) is an operating system (154). Operating systems useful caching web page elements in accordance with display locations of the elements according to embodiments of the present invention include UNIX™, Linux™, Microsoft XP™, AIX™, IBM's i5/OS™, and others as will occur to those of skill in the art. The operating system (154), web browser (126), cache directory (104), and cache retention policy (106), in the example of FIG. 1 are shown in RAM (168), but many components of such software typically are stored in non-volatile memory also, such as, for example, on a disk drive (170). The local cache (102) is depicted in the example of FIG. 1 as stored on a disk drive (170), but readers of skill in the art will immediately recognize that such a cache (102) may also be stored in RAM (168), EEPROM, Flash memory, and so on.

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for caching web page elements in accordance with display locations of the elements according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers, web servers (120, 122, 124), and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for caching web page elements in accordance with display locations of the elements according to embodiments of the present invention include modems for wired dial-up communications, Ethernet (IEEE 802.3) adapters for wired data communications network communications, and 802.11 adapters for wireless data communications network communications.

The arrangement of web servers (120, 122, 124), networks (100), computer (152), and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

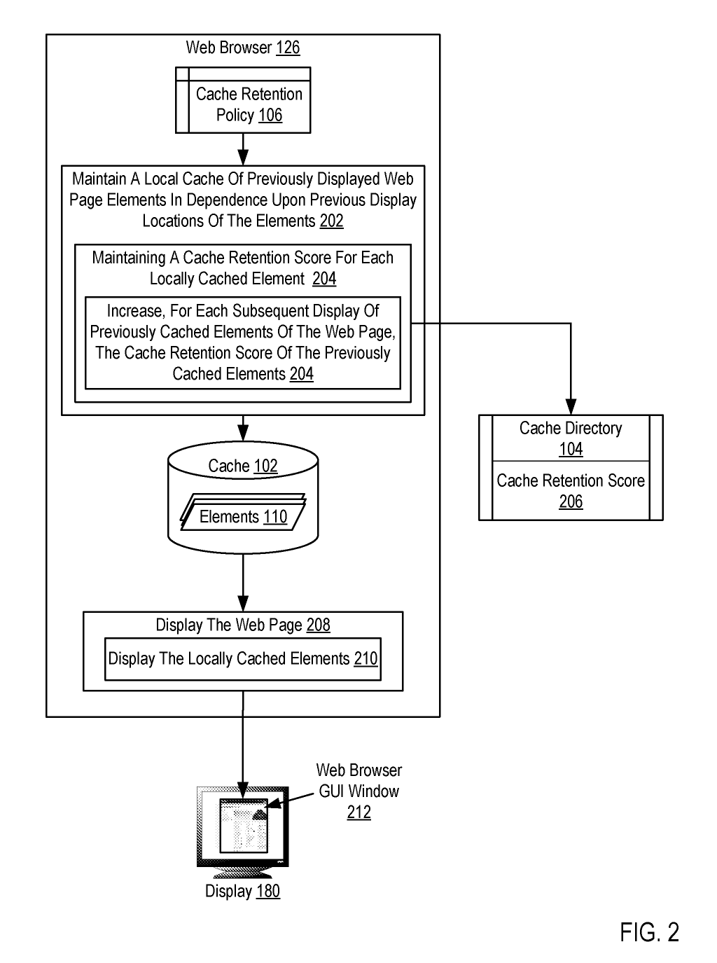

For further explanation, FIG. 2 sets forth a flow chart illustrating an exemplary method for caching web page elements in accordance with display locations of the elements according to embodiments of the present invention. The method of FIG. 2 includes maintaining (202), by a web browser (126) in accordance with a cache retention policy (106), a local cache (102) of previously displayed web page elements (110) in dependence upon previous display locations of the elements (110). In the method of FIG. 2, maintaining (202) a local cache (102) of previously displayed web page elements (110) in dependence upon previous display locations of the elements (110) includes maintaining (204) a cache retention score (206) for each locally cached element (110). The web browser (126) may maintain the cache retention scores in a cache directory (104). In the method of FIG. 2, maintaining (204) a cache retention score (206) for each locally cached element (110) includes increasing (204), for subsequent displays of previously cached elements (110) of the web page, the cache retention score (206) of the previously cached elements (110).

The method of FIG. 2 also includes displaying (208), by the web browser (126), a previously displayed web page. In the method of FIG. 2, displaying (208) a previously displayed web page includes displaying (210) one or more of the locally cached elements (110). Displaying (208), by the web browser (126), a previously displayed web page may be carried out by displaying, in a GUI browser window (212) the elements of the web page, where at least one of the elements (110) is displayed from the cache (110).

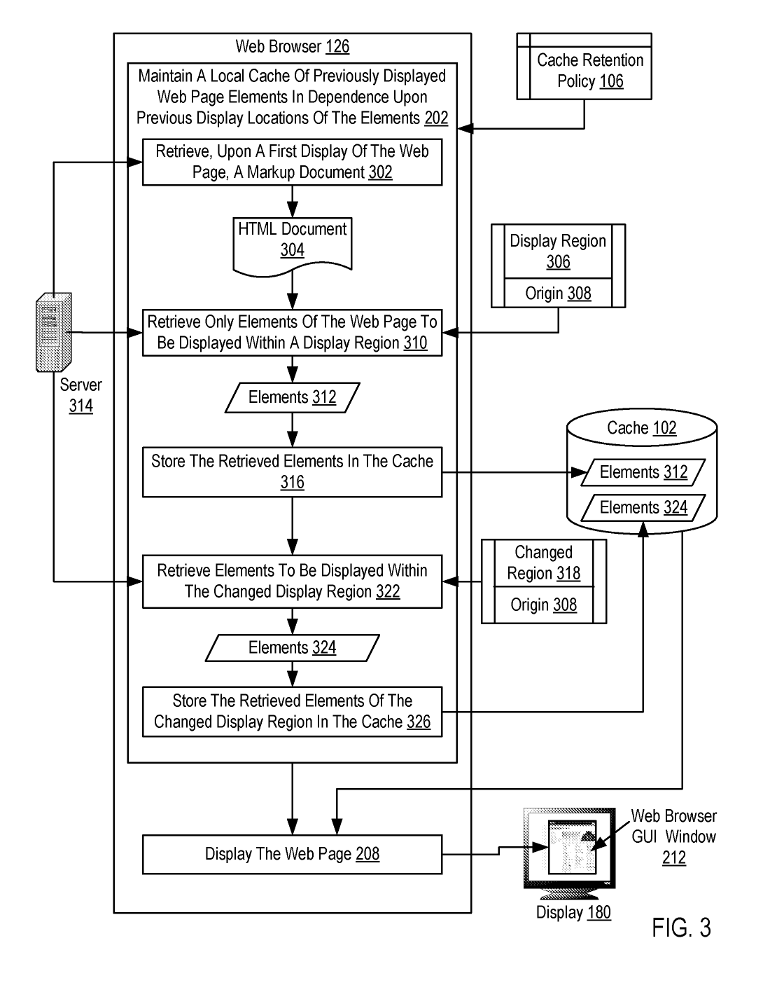

For further explanation, FIG. 3 sets forth a flow chart illustrating a further exemplary method for caching web page elements in accordance with display locations of the elements according to embodiments of the present invention. The method of FIG. 3 is similar to the method of FIG. 2, including as it does, maintaining (202), by a web browser (126) in accordance with a cache retention policy (106), a local cache (102) of previously displayed web page elements (110) in dependence upon previous display locations of the elements (110) and displaying (208), by the web browser (126), a previously displayed web page. The method of FIG. 3 differs from the method of FIG. 2, however, in that in the method of FIG. 3 maintaining (202), by a web browser (126) in accordance with a cache retention policy (106), a local cache (102) of previously displayed web page elements (110) in dependence upon previous display locations of the elements (110) includes retrieving (302), upon a first display of the web page from a server (314), a markup document (304) describing the web page; retrieving (310), in dependence upon the markup document (314), only elements (312) of the web page to be displayed within a display region (306) of a web browser window (212) defined by an origin location (308); and storing (316) the retrieved elements (312) in the cache (102). Also in the method of FIG. 3, maintaining (202), by a web browser (126) in accordance with a cache retention policy (106), a local cache (102) of previously displayed web page elements (110) in dependence upon previous display locations of the elements (110) includes responsive to a change in the display region with respect to the web page, retrieving (322), by the web browser (126) from the server (314) in dependence upon the markup document (304), elements (324) of the web page to be displayed within the changed display region (318) of the web browser window (212); and storing (326) the retrieved elements (324) of the changed display region in the cache (102).

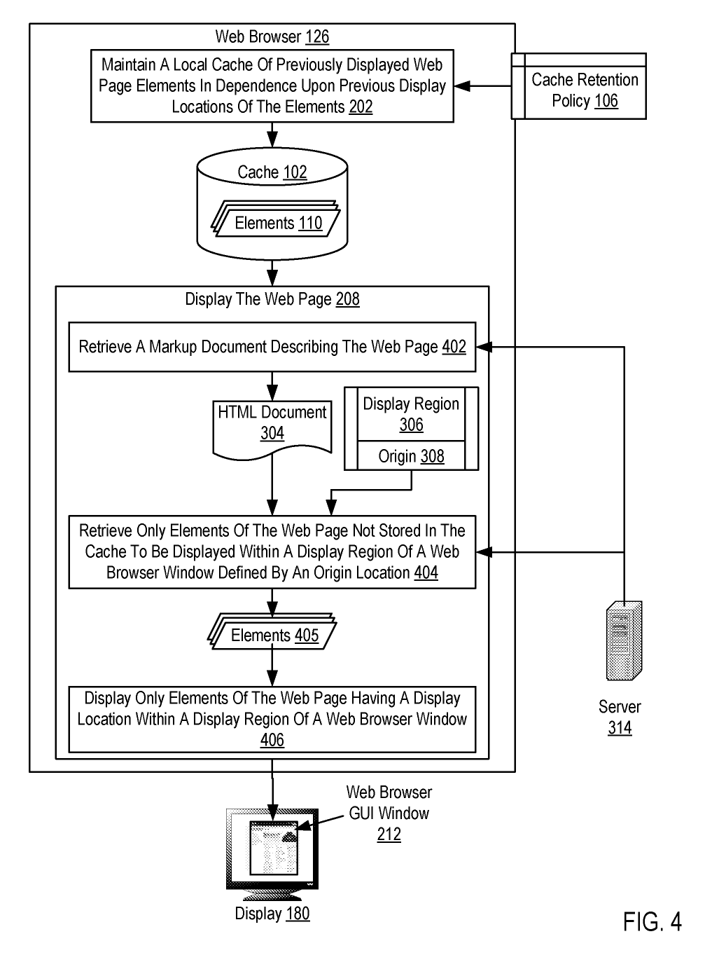

For further explanation, FIG. 4 sets forth a flow chart illustrating a further exemplary method for caching web page elements in accordance with display locations of the elements according to embodiments of the present invention. The method of FIG. 4 is similar to the method of FIG. 2, including as it does, maintaining (202), by a web browser (126) in accordance with a cache retention policy (106), a local cache (102) of previously displayed web page elements (110) in dependence upon previous display locations of the elements (110) and displaying (208), by the web browser (126), a previously displayed web page. The method of FIG. 4 differs from the method of FIG. 2, however, in that displaying (208), by the web browser (126), a previously displayed web page includes retrieving (402), by the web browser (126) from a server (314), a markup document (304) describing the web page; retrieving (404), in dependence upon the markup document (304), only elements (405) of the web page not stored in the cache (102) to be displayed within a display region (306) of a web browser window (212) defined by an origin location (308); and displaying (406), in dependence upon the markup document (304), only elements (405, 110) of the web page having a display location within the display region (306) of the web browser window (212).

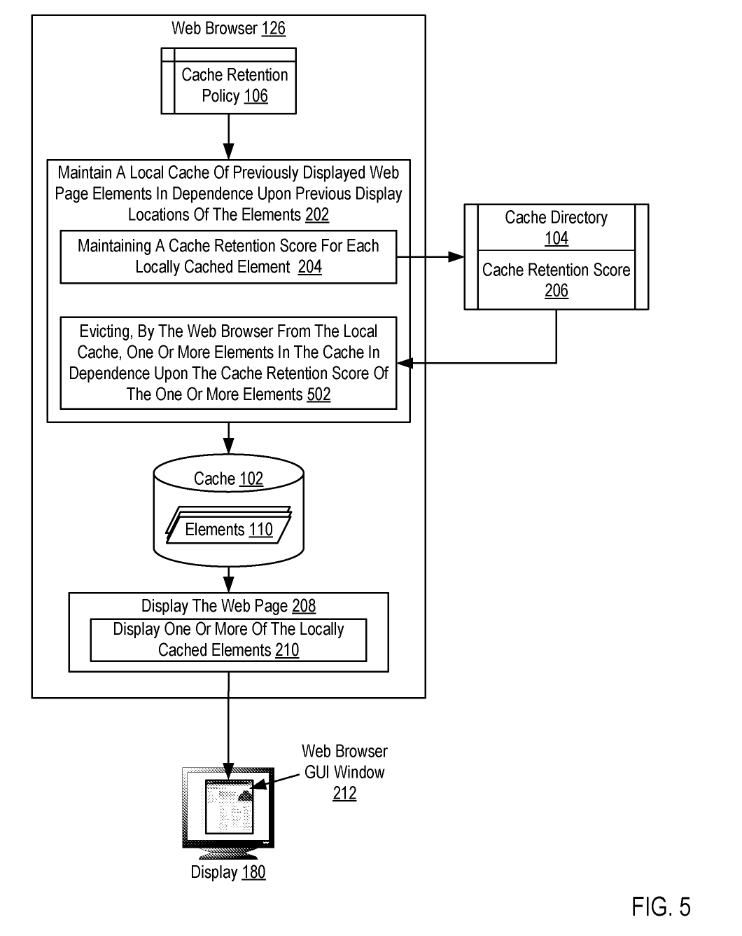

For further explanation, FIG. 5 sets forth a flow chart illustrating a further exemplary method for caching web page elements in accordance with display locations of the elements according to embodiments of the present invention. The method of FIG. 5 is similar to the method of FIG. 2, including as it does, maintaining (202), by a web browser (126) in accordance with a cache retention policy (106), a local cache (102) of previously displayed web page elements (110) in dependence upon previous display locations of the elements (110) and displaying (208), by the web browser (126), a previously displayed web page. The method of FIG. 5 differs from the method of FIG. 2, however, in that maintaining (202), by a web browser (126) in accordance with a cache retention policy (106), a local cache (102) of previously displayed web page elements (110) in dependence upon previous display locations of the elements (110) includes evicting (502), by the web browser (126) from the local cache (102), one or more elements (110) in the cache (102) in dependence upon the cache retention score (206) of the one or more elements (110).

In view of the explanations set forth above, readers will recognize that the benefits of caching web page elements in accordance with display locations of the elements according to embodiments of the present invention include:
Reducing data communications necessary for accessing a web page, thereby reducing user costs for data communications service plans;
Reducing memory storage requirements for each cached web page by limiting the number of elements cached for each web page; and
Increasing efficiency of web browser caching.

Exemplary embodiments of the present invention are described largely in the context of a fully functional computer system for caching web page elements in accordance with display locations of the elements. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of caching web page elements in accordance with display locations of the elements, the method comprising:
maintaining, by a web browser in accordance with a cache retention policy, a local cache of previously displayed web page elements in dependence upon previous display locations of the elements including maintaining a cache retention score for each locally cached element; and
displaying, by the web browser, a previously displayed web page including displaying one or more of the locally cached elements.

2. The method of claim 1 wherein maintaining, by a web browser in accordance with a cache retention policy, a local cache of previously displayed web page elements in dependence upon previous display locations of the element further comprises:
retrieving, upon a first display of the web page from a server, a markup document describing the web page;
retrieving, in dependence upon the markup document, only elements of the web page to be displayed within a display region of a web browser window defined by an origin location; and
storing the retrieved elements in the cache.

3. The method of claim 2 further comprising:
responsive to a change in the display region with respect to the web page, retrieving, by the web browser from the server in dependence upon the markup document, elements of the web page to be displayed within the changed display region of the web browser window; and
storing the retrieved elements of the changed display region in the cache.

4. The method of claim 1 wherein maintaining a cache retention score for each locally cached element further comprises increasing, for subsequent displays of previously cached elements of the web page, the cache retention score of the previously cached elements.

5. The method of claim 1 wherein displaying, by the web browser, a previously displayed web page including displaying one or more of the locally cached elements further comprises:
retrieving, by the web browser from a server, a markup document describing the web page;
retrieving, in dependence upon the markup document, only elements of the web page not stored in the cache to be displayed within a display region of a web browser window defined by an origin location; and
displaying, in dependence upon the markup document, only elements of the web page having a display location within the display region of the web browser window.

6. The method of claim 1 wherein maintaining, by a web browser in accordance with a cache retention policy, a local cache of previously displayed web page elements in dependence upon previous display locations of the elements further comprises:
evicting, by the web browser from the local cache, one or more elements in the cache in dependence upon the cache retention score of the one or more elements.

7. An apparatus for caching web page elements in accordance with display locations of the elements, the apparatus comprising a computer processor, a computer memory operatively coupled to the computer processor, the computer memory having disposed within it computer program instructions capable of:
maintaining, by a web browser in accordance with a cache retention policy, a local cache of previously displayed web page elements in dependence upon previous display locations of the elements including maintaining a cache retention score for each locally cached element; and
displaying, by the web browser, a previously displayed web page including displaying one or more of the locally cached elements.

8. The apparatus of claim 7 wherein maintaining, by a web browser in accordance with a cache retention policy, a local cache of previously displayed web page elements in dependence upon previous display locations of the element further comprises:
retrieving, upon a first display of the web page from a server, a markup document describing the web page;
retrieving, in dependence upon the markup document, only elements of the web page to be displayed within a display region of a web browser window defined by an origin location; and
storing the retrieved elements in the cache.

9. The apparatus of claim 8 further comprising:
responsive to a change in the display region with respect to the web page, retrieving, by the web browser from the server in dependence upon the markup document, elements of the web page to be displayed within the changed display region of the web browser window; and
storing the retrieved elements of the changed display region in the cache.

10. The apparatus of claim 7 wherein maintaining a cache retention score for each locally cached element further comprises increasing, for subsequent displays of previously cached elements of the web page, the cache retention score of the previously cached elements.

11. The apparatus of claim 7 wherein displaying, by the web browser, a previously displayed web page including displaying one or more of the locally cached elements further comprises:
retrieving, by the web browser from a server, a markup document describing the web page;
retrieving, in dependence upon the markup document, only elements of the web page not stored in the cache to be displayed within a display region of a web browser window defined by an origin location; and
displaying, in dependence upon the markup document, only elements of the web page having a display location within the display region of the web browser window.

12. The apparatus of claim 7 wherein maintaining, by a web browser in accordance with a cache retention policy, a local cache of previously displayed web page elements in dependence upon previous display locations of the elements further comprises:
evicting, by the web browser from the local cache, one or more elements in the cache in dependence upon the cache retention score of the one or more elements.

13. A computer program product for caching web page elements in accordance with display locations of the elements, the computer program product disposed in a computer readable, signal bearing medium, the computer program product comprising computer program instructions capable of:
maintaining, by a web browser in accordance with a cache retention policy, a local cache of previously displayed web page elements in dependence upon previous display locations of the elements including maintaining a cache retention score for each locally cached element; and
displaying, by the web browser, a previously displayed web page including displaying one or more of the locally cached elements.

14. The computer program product of claim 13 wherein maintaining, by a web browser in accordance with a cache retention policy, a local cache of previously displayed web page elements in dependence upon previous display locations of the element further comprises:
retrieving, upon a first display of the web page from a server, a markup document describing the web page;
retrieving, in dependence upon the markup document, only elements of the web page to be displayed within a display region of a web browser window defined by an origin location; and
storing the retrieved elements in the cache.

15. The computer program product of claim 14 further comprising:
responsive to a change in the display region with respect to the web page,
retrieving, by the web browser from the server in dependence upon the markup document, elements of the web page to be displayed within the changed display region of the web browser window; and
storing the retrieved elements of the changed display region in the cache.

16. The computer program product of claim 13 wherein maintaining a cache retention score for each locally cached element further comprises increasing, for subsequent displays of previously cached elements of the web page, the cache retention score of the previously cached elements.

17. The computer program product of claim 13 wherein displaying, by the web browser, a previously displayed web page including displaying one or more of the locally cached elements further comprises:
retrieving, by the web browser from a server, a markup document describing the web page;
retrieving, in dependence upon the markup document, only elements of the web page not stored in the cache to be displayed within a display region of a web browser window defined by an origin location; and
displaying, in dependence upon the markup document, only elements of the web page having a display location within the display region of the web browser window.

18. The computer program product of claim 13 wherein maintaining, by a web browser in accordance with a cache retention policy, a local cache of previously displayed web page elements in dependence upon previous display locations of the elements further comprises:
evicting, by the web browser from the local cache, one or more elements in the cache in dependence upon the cache retention score of the one or more elements.

19. The computer program product of claim 13 wherein the signal bearing medium comprises a recordable medium.

20. The computer program product of claim 13 wherein the signal bearing medium comprises a transmission medium.
